(19) United States
(12) Patent Application Publication
(10) Pub. No.: US 2014/0377444 A1
(43) Pub. Date: Dec. 25, 2014

(54) IN-BOTTLE PASTEURIZATION

(71) Applicant: The Coca-Cola Company, Atlanta, GA (US)

(72) Inventors: Mary Tanzosh, Smyrna, GA (US); Holly Symolon, Atlanta, GA (US); Peter Simpson, Atlanta, GA (US)

(21) Appl. No.: 13/926,909

(22) Filed: Jun. 25, 2013

(51) Int. Cl. A23L 2/46; A23L 2/02

(52) U.S. Cl. CPC A23L 2/46; A23L 2/02
USPC 426/599

(57) ABSTRACT

A packaged food article or beverage may include a consumer package, a processed food composition including a spoilage microorganism, and a liquid being at a temperature in a predetermined range applied to the processed food composition to form a first mixture in the consumer package that, as a result of the liquid being in the predetermined range, causes the spoilage microorganism to be substantially inactivated.

### BACKGROUND OF THE INVENTION

Pasteurization of food is performed by heating the food, generally liquids, to a temperature within a certain temperature range for a certain amount of time to kill or inactivate microorganisms. By reducing or eliminating the microorganisms, spoilage of the food is slowed and diseases that may result from people ingesting the pathogens are greatly reduced. As understood in the art, sterilization of foods is performed by heating the food to higher temperatures than pasteurization. Sterilization results in foods that are less acceptable from a taste perspective of consumers than pasteurization.

Pasteurization of different foods use different pasteurization techniques. For example, pasteurization of juice with a high amount of pulp in a mass production setting is often performed using a dual-stream pasteurization process. One stream or production line processes and pasteurizes the pulp, and another stream or production line processes and pasteurizes the juice. By pasteurizing both juice ingredients (i.e., pulp and juice), a producer of a juice product with juice and pulp is assured that minimal or no spoilage microorganisms grow in the resulting juice product.

In some traditional methods, pulp is produced from fruit and frozen in large barrels or other containers to preserve the pulp for a period of time until ready for inclusion in a beverage, such as orange juice, or food. The process of preparing the frozen pulp includes crushing the ice containing the pulp, producing a pulp slurry by mixing the crushed frozen pulp with water and syrup, and heating the pulp slurry to a pasteurization temperature under a certain minimum back pressure, generally 0.3 Bar or higher, to cause the microorganisms to be inactivated. The pasteurized pulp slurry is then poured into a package, such as an orange juice container, for mixing with the pasteurized juice to produce a consumer food or beverage product.

Pasteurization of the pulp is both costly and inefficient. The overall cost of pasteurizing the pulp is as a result of cost of energy to heat the pulp to a pasteurization temperature using heating equipment, cost of maintaining the pasteurization equipment, cost of time to pasteurize and process the pulp, cost of pulp due to inefficiency of pasteurizing the pulp, cost of personnel to operate and maintain the manufacturing equipment, and capital costs of the pulp pasteurization equipment for new food or beverage processing operations.

Inefficiency in pasteurizing the pulp is a result of macerating or destroying the pulp to a size that is not perceptible or acceptable to a consumer. The maceration of the pulp is as a result of a combination of the heating of the pulp to pasteurization temperatures under back. It is well understood that maceration of pulp due to, in part, the pasteurization process of the pulp results in a 50% or higher loss of usable pulp to meet consumer acceptable taste requirements. As an example, if juice is to contain 5%-7% pulp, then 15%-20% or more pulp as a percentage of the pulp slurry is used due to maceration of the pulp.

### SUMMARY

The principles of the present invention provide for pasteurizing pulp in a package by mixing unpasteurized pulp with liquid at a pasteurization temperature, thereby enabling the heated liquid to pasteurize the pulp. As a result, costs of manufacturing and inefficiency of pulp processing are significantly reduced as pasteurization of the pulp prior to entering the package may be eliminated.

One embodiment of a method for producing a packaged food article or beverage may include processing a first food source including a spoilage microorganism along a first processing path. The first processing path may limit temperature of the first food source to be below a temperature level that causes the spoilage microorganism to be inactivated. A second food source may be processed along a second processing path. The second processing path may heat the second food source to be in a predetermined temperature range that causes spoilage microorganisms in the second food source to be substantially inactivated when in the predetermined temperature range for a predetermined period of time. A package may be filled with the first and the second food sources. The second food source, when mixed with the first food source, may be in the predetermined temperature range for the predetermined period of time in the package to cause the spoilage microorganism to be inactivated. The package may be a consumer package.

One embodiment of a system for producing a packaged food article or beverage may include a first processing path configured to process a first food source including a spoilage microorganism. The first processing path may limit temperature of the first food source to be below a temperature level that causes the spoilage microorganism to be inactivated. A second processing path may be configured to process a second food source, where the second processing path may heat the second food source to be in a predetermined temperature range that causes spoilage microorganisms in the second food source to be substantially inactivated when in the predetermined temperature range for a predetermined period of time. The first and second processing paths may further be configured to fill a package with the first and the second food sources. The second food source, when mixed with the first food source, may be in the predetermined temperature range for the predetermined period of time in the package to cause the spoilage microorganism to be inactivated.

One embodiment of a method of retrofitting a pulp slurry processing subsystem may include providing the pulp slurry processing subsystem having a fluid path inclusive of a heater element in fluid communication with a blending tank and a filler. The heater element may be configured to pasteurize blended pulp slurry from the blending tank. A bypass conduit may be fluidly connected along the fluid path between the blending tank and the filler, where the bypass conduit causes the blended pulp slurry from the blending tank to bypass the heater element.

One embodiment of a packaged food article or beverage may include a consumer package, a processed food composition including a microorganism, and a liquid being at a temperature in a predetermined range applied to the processed food composition to form a first mixture in the consumer package that, as a result of the liquid being in the predetermined range, causes the microorganism to be substantially inactivated.

One embodiment of a method for manufacturing a packaged food article or beverage may include providing a processed food composition including a microorganism. A liquid being used to form the food article or beverage may be pasteurized, where the pasteurization includes heating the liquid to a predetermined temperature range. In a consumer package, the liquid in the predetermined range and the processed food composition may be combined to form a first mixture, such that the liquid in the predetermined range causes the microorganism to be substantially inactivated.

### BRIEF DESCRIPTION OF THE DRAWINGS

Illustrative embodiments of the present invention are described in detail below with reference to the attached drawing figures, which are incorporated by reference herein and wherein:

FIG. 1 is a schematic diagram of an illustrative system for performing a dual filler process for processing pulp and liquid to produce a juice beverage;

FIG. 2 is a schematic diagram of an alternative illustrative subsystem for processing pulp in producing a fruit beverage;

FIG. 3 is a schematic diagram of another alternative illustrative subsystem for processing pulp in producing a fruit beverage;

FIG. 4 is a schematic diagram of yet another alternative illustrative subsystem for processing pulp in producing a fruit beverage;

FIG. 5 is a flow diagram of an illustrative pulp processing embodiment;

FIG. 6 is a graph of illustrative processing results showing change in temperature and survival of Gluconobacter spp during heating to 68° C. in three pH formulations;

FIG. 7 is a graph of illustrative processing results showing change in temperature and survival of Saccharomyces cerevisiae during heating to 68° C. in three pH formulations;

FIG. 8 is a graph of illustrative processing results showing change in temperature and survival of Penicillium crysogenum during heating to 68° C. in three pH formulations;

FIG. 9 is a graph of illustrative processing results showing the temperature change of a juice formulation, in this case the Minute Maid Pulpy juice product;

FIG. 10 is a table showing illustrative results showing temperatures at which beverages were pasteurized after inoculation with a cocktail of spoilage yeast are produced.

FIG. 11 is a table showing illustrative results showing temperatures at which beverages were pasteurized after inoculation with a cocktail of spoilage yeast are produced with increased microbial load and reduced inversion time;

FIG. 12 is a table showing illustrative process test results with spoilage yeast;

FIG. 13 is a table showing illustrative process test results with mold and or yeast;

FIG. 14 is a table showing illustrative process test results with peach bits; and

FIG. 15 is a flow diagram of a process for producing a packaged food article or beverage.

### DETAILED DESCRIPTION

According to principles of the present invention, a food or beverage is pasteurized in a container by combining it with hot fluid. In some embodiments this occurs in the absence of aseptic conditions. In certain embodiments, principles of the present disclosure include mixing unpasteurized food or beverage with liquid at pasteurizing temperatures to pasteurize the unpasteurized food or beverage. Mixing may include simply combining, stirring, shaking, inverting, or any other process that integrates the unpasteurized food or beverage with liquid at pasteurizing temperatures to pasteurize the unpasteurized food or beverage.

In certain embodiments, the principles of the present invention provide for pasteurizing pulp or food bits in a package, such as but not limited to a bottle, by mixing unpasteurized pulp or food bits with liquid under pasteurization temperature, thereby enabling the heated liquid to pasteurize the pulp. As a result, costs of manufacturing and inefficiency of pulp processing are significantly reduced as pasteurization of the pulp prior to entering the package may be eliminated.

In certain embodiments, the disclosure provides pasteurizing processed food compositions in a package by mixing an unpasteurized food compositions with liquid at a temperature in a predetermined range (in-package processing), thereby enabling the heated liquid to pasteurize the food. Mixing the liquid and food in the packaging and holding the temperature for a certain time at an equilibrium temperature kills or substantially inactivates microorganisms.

“In-package” processing is meant as pasteurizing food, such as or pulp or food bits, by heated liquid in a consumer package. Any consumer packaging finds use in the methods described herein. In certain embodiments, bottles, including glass, plastic bottles, or other package materials, may be used.

Generally, the consumer packaging permits in-packaging pasteurization of the food article or beverage. In various embodiments, consumer packaging may be plastic bottles, glass bottles, aluminum cans, cartons, cups, or other suitable material.

In certain embodiments, the consumer packaging may be composed of metal, polymeric materials such as polypropylene or polyethylene terephthalate (PET) based polyesters and polystyrenes, paper-based materials, silica, ceramic, glass or the like. For example, the bottle may be plastic or glass. For example, the bottle is plastic and formed from a polymer based thermoplastic material. In various embodiments, the consumer packaging may comprise polymer materials, such as polyethylene naphthalate (PEN), polyketones such as ethylene carbon monoxide copolymer and liquid crystal polymers (LCP) which can be used alone or mixed with other polymers such as, e.g., PET. In certain embodiments, metal-based consumer packaging, such as aluminum cans are employed. The consumer packaging may be disposable or non-disposable.

In certain embodiments, the consumer packaging may exhibit improved gas, odor, flavor and/or aroma permeation barrier properties. In certain embodiments, the consumer packaging has a good stability against tipping over, for example during filling and/or in its empty condition, e.g. when the container is handled. Additionally, in certain embodiments, the consumer packaging has a closure which is easy to remove and/or a neck configuration and/or a mouth dimension that makes it convenient to consume the beverage directly from the bottle.

In certain embodiments, in-package processing reduces or eliminates heat-sensitive microorganisms that can spoil the food or that are pathogens or spoilage microorganisms. Heat-sensitive microorganism are defined as being microorganisms that are substantially inactivated by the in-packaging pasteurization process disclosed herein, this includes incubation at an equilibrium temperature for a holding time. Substantially inactivated microorganism are microorganism that are killed or unable to reproduce. The equilibrium temperature is the temperature reached by the packaged food article or beverage after the processed food composition and the liquid having a temperature in a predetermined range are mixed. The equilibrium temperature may be reached between 1 second and 2 minutes after mixing or up to 3 or 5 minutes after mixing. In various embodiments, the equilibrium temperature is between 66° C. and 80° C., 70° C. and 80° C., 72° C. and 80° C., or 75° C.-80° C. The holding time is the length of time the packaged food article or beverage is within the range of the equilibrium temperature. In various embodiments, the holding time may be in the range of 1-300 seconds, 1-200 seconds, or 1-100 seconds.

By reducing or eliminating heat-sensitive microorganisms, spoilage of the food is slowed, and diseases that may result from ingesting the food are prevented. In addition to destroying heat-sensitive microorganisms, pasteurization and the in-package process may inactivate unwanted enzymes while retaining optimum flavor.

In contrast to pasteurization, sterilization of foods is meant to kill all microorganisms including heat-resistant microorganisms. Sterilization of foods is performed by heating the food to higher temperatures than pasteurization. Sterilization results in foods that are less acceptable from a taste perspective of consumers. In various embodiments, pasteurization causes bacteria inactivation to levels less than the detection limit, less than 50,000, 100,000 or 250,000 colony-forming units per gram of the packaged food article or beverage.

Any food may be pasteurized in this manner, e.g., in-package processing as long as it is mixed with a liquid or steam of adequate temperature for a sufficient time. For instance, any fruits, vegetables, nuts and the like may find use in the methods described herein. Certain embodiments include citrus pulp, orange pulp, grapefruit pulp, or peach chunks, mango chunks, Aloe vera chunks, or coco de nato. Other embodiments may include banana chunks or apple chunks. The processed food composition may include pulp or fruit bits from citrus fruits such as oranges, sweet oranges, clementines, kumquats, limes, leeche limes, satsumas, mandarins, tangerines, citrons, pummelos, lemons, rough lemons, grapefruits, tangerines, tangelos, hybrids thereof, or combinations thereof. In addition, the processed food composition may comprises pulp or fruit bits from non-citrus fruits such as kiwi, mango, grapes, banana, berries, pears, apples, peach, pineapple, melon, apricots, strawberries, raspberries, blackberries, blackcurrants, blueberry, red currant, nectarine, cranberry, passion fruit, papaya, lychees, pomegranate, fig, plum, cherry, gooseberry, summer squash, persimmon, dates, guava, rhubarb, coconuts, or combinations thereof. In certain embodiments, the processed food composition includes food-grade gel particles that are composed of food-grade polymers including but not limited to gelatin, alginate, or pectin or particles formed through culturing.

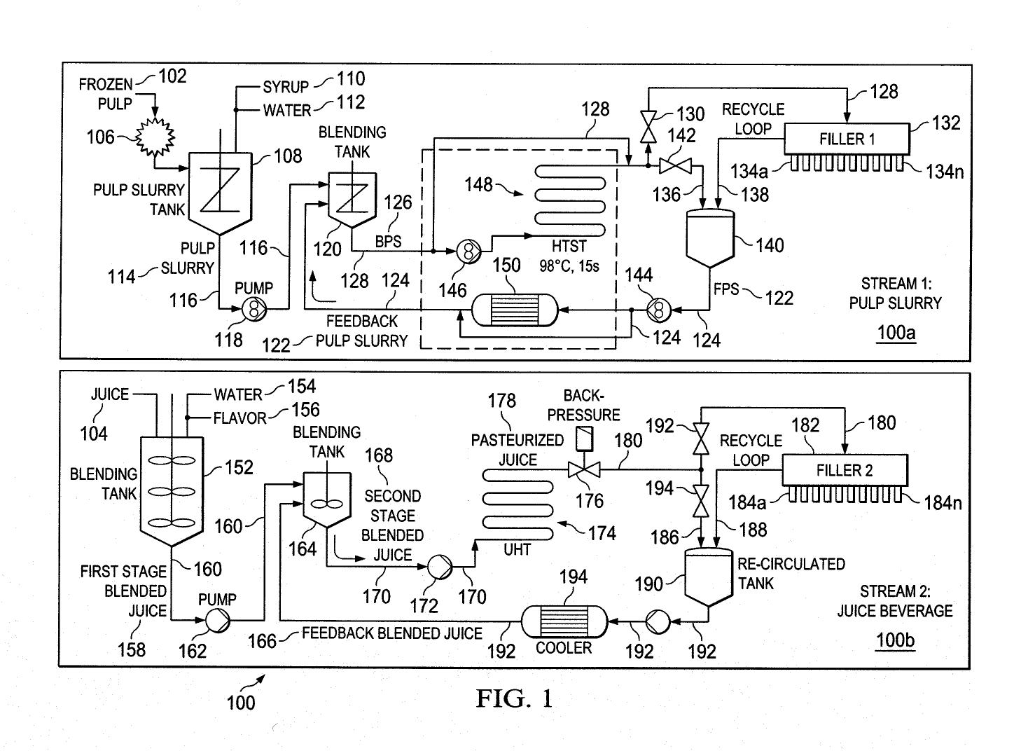

With regard to FIG. 1, a schematic diagram of an illustrative system 100 for performing illustrative dual filler processes in parallel in producing a fruit beverage is shown. The system 100 may include two subsystems 100a and 100b, where the subsystem 100a may process a first frozen food source, such as frozen pulp 102, and the subsystem 100b may process a liquid, such as juice 104. For the purposes of this description, the subbsystem 100a is described with reference to frozen pulp, but it is contemplated that alternative foods that are frozen or are not frozen are contemplated.

With regard to subsystem 100a, in processing the frozen pulp 102, an ice crusher 106 or other device for breaking or reducing ice in which the pulp is being maintained may be utilized. The crushing ice with the pulp may be placed or flowed into a pulp slurry tank 108 in which the syrup 110 and water 112 may be mixed to produce a pulp slurry 114. The syrup 110 and water 112 are used to produce the pulp slurry 114 with certain flow, density, and taste characteristics, as understood in the art.

The pulp slurry 114 may be flowed through a conduit path 116 through use of a pump 118, such as a rotary pump, or other flow mechanism into a blending tank 120. The blending tank 120 may be utilized to blend the pulp slurry 114 with a feedback pulp slurry 122 via feedback conduit 124, as further described hereinbelow. The blending tank 120 may be used to maintain a blended pulp slurry within a given temperature range, water to pulp ratio, and/or any other characteristic. The given temperature may be between approximately 15° C. and approximately 65° C., which is below a pasteurization temperature. Blended pulp slurry 126 may be flowed through conduit path 128, optionally through a valve 130, to a filler 132, such as a piston filler. The filler 132 may include one or more filler spouts 134a-134n (collectively 134) to fill containers (not shown) with a certain amount of pulp.

As understood in the art, pulp and other food sources have to continue flowing through conduits to avoid clogging the conduits or getting caught in the conduits and decomposing in the conduits. As a result, recycle or feedback conduits 136 and 138 are provided to enable blended pulp slurry 126 that cannot be used or processed fast enough by the filler 132 to be offloaded into a recirculation tank 140. The recirculation tank 140 may be configured to maintain the feedback pulp slurry 122 in a certain viscous state by maintaining the feedback pulp slurry in a certain temperature range below a pasteurization temperature. For example, the temperature range may be between approximately 15° C. and approximately 65° C. A valve 142 may be included along conduit 136 to enable, limit, or prevent blended pulp slurry 126 to flow into the recirculation tank 140. The feedback pulp slurry 122 may be fed back via conduit 124 via a pulp 144.

Between the blending tank 120 and filler 132, a pump 146, such as rotary pump, heat exchanger 148, and cooler 150 that have historically been used to pasteurize the blended pulp slurry 126 may be removed or bypassed in accordance with the principles of the present invention, as the blended pulp slurry 126 is to be pasteurized in containers (not shown) filled by the filler 132. As a result of bypassing or eliminating the pump 146 and heat exchanger 148, pasteurization temperatures and back pressures that cause high levels of maceration of the pulp are eliminated. The cooler 150 in the feedback may also be eliminated or bypassed as the blended pulp slurry 126 is flowed at a temperature below a pasteurization temperature, thereby being able to flow back into the blending tank 120 without being cooled. As previously described, elimination of the pump 146, heat exchange 148, and cooler 150 significantly reduces maceration of the pulp, cost of heating and cooling resources, capital costs for new equipment, maintenance costs, labor costs to maintain the equipment, processing time, and so on.

Continuing with FIG. 1, the subsystem 100b is conventional and may include a blending tank 152 in which juice 104 may be blended with water 154 and flavor 156 to produce a first stage blended juice 158. The first stage blended juice 158 may be flowed from the blending tank 152 via conduit 160. A pump 162, such as a centrifugal pump, may be utilized to control flow of the first stage blended juice 158 via the conduit 160 to blending tank 164. The blending tank 164 may be utilized to blend the first stage blended juice 158 with feedback blended juice 166, as further described herein, to create a second stage blended juice 168.

The second stage blended juice 168 may be passed via a conduit 170 using a pump 172, such as a centrifugal pump, to a heating element 174, such as a heat exchanger. The heating element 17 may cause the second stage blended juice 168 to be heated to a predetermined temperature range, such as a pasteurization temperature range, that causes a majority of pathogens to be inactivated and a majority of non-pathogens to remain active.

Further provided in the subsystem 100b of FIG. 1 is a valve 176 that may be used to cause a back pressure in the conduit 170 to limit flow of pasteurized juice 178 (i.e., heated second stage blended juice 168). The pasteurized juice 168 may be flowed via conduit 180 to a filler 182 having one or more filler spouts 184a-184n (collectively 184). The filler 182 may be a piston filler or any other type of filler, as understood in the art. Similar to the subsystem 102a, recycle or feedback conduits 186 and 188 may be utilized to offload the pasteurized juice 178 from being dispensed from the filler 182 into containers (not shown). In the event that the filler 182 cannot dispense as much pasteurized juice 178 as is being produced. Such recycling limits the potential that the pasteurized juice will remain stagnant in the conduit 180 or filler 182, as understood in the art. The offloaded or recycled pasteurized juice 178 may be temporarily stored in a recirculation tank 190. Two valves 192 and 194 may be used to limit the flow of pressurized juice 178 to the filler 182 and recirculation tank 190, respectively. From the recirculation tank 190, the feedback blended juice 166, which has already been pasteurized, may be flowed back into the blending tank 164 via conduit 192 by a pump 192 through cooler 194. The cooler 194 may be utilized to lower temperature of the pasteurized juice 178, thereby avoiding overheating the second stage blended juice 168 as it passes through the heater 174.

In one embodiment, containers may be filled with the pasteurized juice 178 prior to the containers being filled with the blended pulp slurry 126 dispensed by the filler 132. Alternatively, the blended pulp slurry 126 may be dispensed into the containers after the containers have been filled with the pasteurized juice 178. Whether the containers are filled with the blended pulp slurry 126 prior to, after, or simultaneously with the pasteurized juice 178, an equilibrium temperature resulting from temperatures of the pasteurized juice 178 and the blended pulp slurry 126 shall be in a temperature range long enough to pasteurize the blended pulp slurry 126 in the containers. The ability to pasteurize pulp or other food materials (e.g., nuts) by another food product component (e.g., fruit juice) in a mass production operation was unexpected and a contrary approach to industry standards and practices.

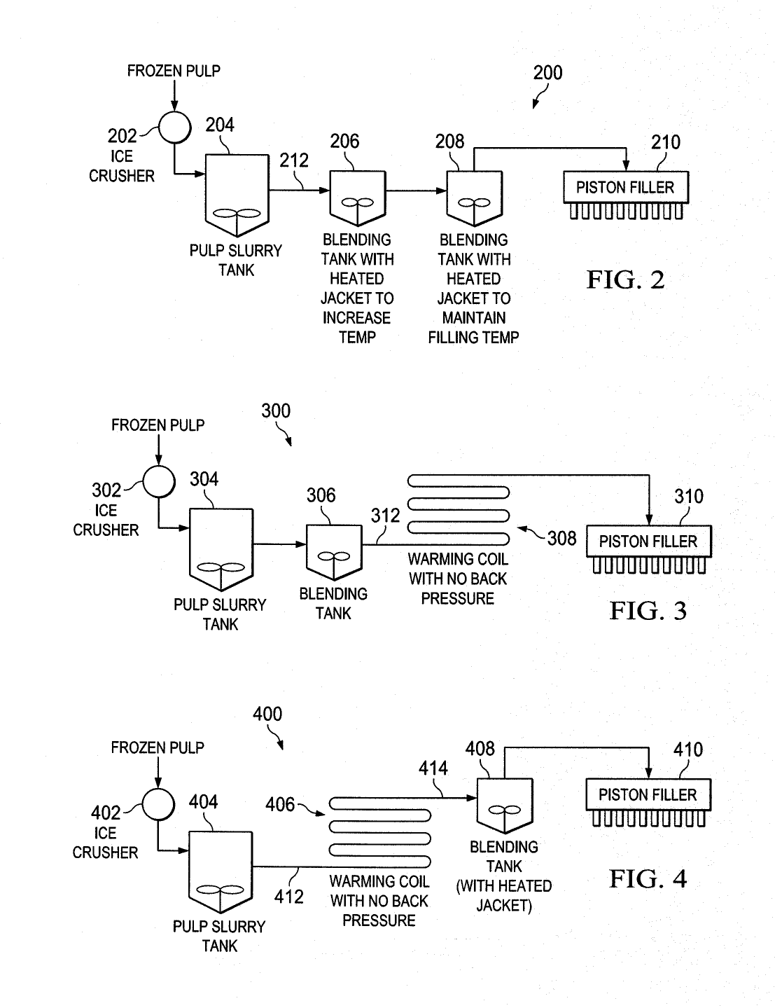

With regard to FIG. 2, a schematic diagram of an alternative illustrative subsystem 200 for processing pulp in producing a fruit beverage is shown. The subsystem 200 may include a pulp slurry tank 204, first blending tank 206, second blending tank 208, and filler 210. The first blending tank 206 may utilize a heating jacket or other heating element to increase temperature of pulp slurry 212. The second blending tank 208 may also include a heating jacket or other heating element to maintain a filling temperature of the pulp slurry 212 below that of a pasteurization temperature prior to filling the pulp slurry into containers by the filler 210. As a result on not heating the pulp slurry 212, much cost is saved due to using less energy, production volume is increased, and less maceration of the pulp results. The filler 210 may be a piston filler or other filler for filling consumer or other containers, as understood in the art. Recirculation, as described with regard to FIG. 1, may be utilized in the subsystem 200.

With regard to FIG. 3, a schematic diagram of another alternative subsystem 300 for processing pulp in producing a fruit beverage is shown. The subsystem 300 may include an ice crusher 302, pulp slurry tank 304, blending tank 306, heating device 308, and filler 310. In this case, the heating device 308 may be a warming coil and may be configured to heat blended pulp slurry 312 to a temperature below a pasteurization temperature. Recirculation, as described with regard to FIG. 1, may be utilized in the subsystem 300.

With regard to FIG. 4, a schematic diagram of yet another alternative illustrative subsystem 400 for processing pulp in producing a fruit beverage is shown. The subsystem 400 may include an ice crusher 402, pulp slurry tank 404, heating device 406, blending tank 408, and filler 410. The heating element 406 may be a warming coil that does not utilize back pressure to warm pulp slurry 412. The blending tank may utilize a heating element, such as a heating jacket, to heat warmed pulp slurry 414. Both the heating device 406 and blending tank 408 may heat the pulp slurry to a temperature below that of a pasteurization temperature. Recirculation, as described with regard to FIG. 1, may be utilized in the subsystem 300.

Accordingly, in certain embodiments, frozen food is thawed and reduced in size by placing the food in an ice crusher to break up the material as necessary. The thawed and/or reduced food, e.g. food bits, is then added to a consumer packaging as described herein. To the consumer packaging is then added heated liquid, e.g., water, sparkling water, juice such as fruit juice or vegetable juice, broth and the like. The heated juice or liquid may have a temperature in the range of 72° C. to about 87° C., 75° C. to about 87° C., 79° C. to about 87° C., 81° C. to about 87° C., 82° C. to about 87° C., 85° C. to about 87° C., 72° C. to about 90° C., 75° C. to about 90° C., 79° C. to about 90° C., 81° C. to about 90° C.; 82° C. to about 90° C., 85° C. to about 90° C., 83° C. to about 86° C., or 84° C. to about 85° C. In some embodiments the temperature is between 81° C. and 87° C. In certain embodiments, the mixture of thawed food and heated liquid may be kept at the equilibrium temperature for 1-300 seconds, 1-200 seconds, 1-100 seconds, or 1-50 seconds or at least 5 seconds. In certain embodiments, the temperature of the mixture will be between 40° C. and 90° C., 50° C. and 90° C., 55° C. and 85° C., 60° C. and 80° C., 60° C. and 70° C., or 66° C. and 80° C.

In some embodiments, the mixture may be agitated or inverted to ensure mixing of the processed food and liquid. In certain embodiments, the consumer packaging may be capped or sealed with a lid. In certain embodiments, the capped or sealed consumer package may be inverted to ensure pasteurization of the inside of the consumer packaging.

In certain embodiments, the principles of the present invention provide a method of making a beverage containing equal food/pulp content that requires less food/pulp during processing.

In various embodiments the weight percentage of the processed food composition (e.g., pulp) in the packaged food article or beverage may be about 1% to about 40% or about 1% to about 30%

Once processing as described herein is completed, in certain embodiments, the principles of the present invention provide a pasteurized beverage mixture. The packaged mixture can be stored and/or shipped to consumers.

One of the surprising an unexpected features of the in-packaging process is that less processed food composition (e.g., pulp) is needed to achieve the same level of pulp content in a juice/pulp mixture compared to when pulp and juice are pasteurized separately and mixed thereafter. Therefore, the in-packaging process required less pulp then any other methods. In addition, the pulp is of higher quality. For example, the pulp that is in-package pasteurized may end up being longer or larger than any other method.

The in-packaging process may result in a substantial saving in time, increased energy efficiency and reduction in energy usage, and reduction in cost of production. The in-packaging process also enhances work safety as the processed food composition does not have to be pasteurized separately.

In certain embodiments, the pasteurization of pulp occurs in the package as a result of heat exchanged from the pasteurized juice. This in-package pasteurization offers several unexpected and surprising results including: 1) reduced cost of goods (COGs) in pulp as a result of decreased maceration from back-pressure requirements for pulp pasteurization, 2) reduced energy by removing/reduction of heating stream, 3) decreased start-up capital costs for new production lines, 4) increased product quality, and 5) increased safely for workers in the processing facility as the processed food composition does not have to be pasteurized separately.

### Example 1

### In-Package Temperature Monitoring

For monitoring the temperature change of the liquid in the package after pasteurized juice was added, a cap was fitted with a food thermometer by making a small hole in the top of a plastic bottle. In certain embodiments, the process was carried out with 84° C. juice and 22° C. pulp. After the liquid in the package reached a temperature equilibrium (˜45s), the temperature was recorded with the bottle upright for 4 minutes near the edges of the bottle (with the expectation that near the edge of the plastic bottle was where heat loss would occur at the fastest rate).

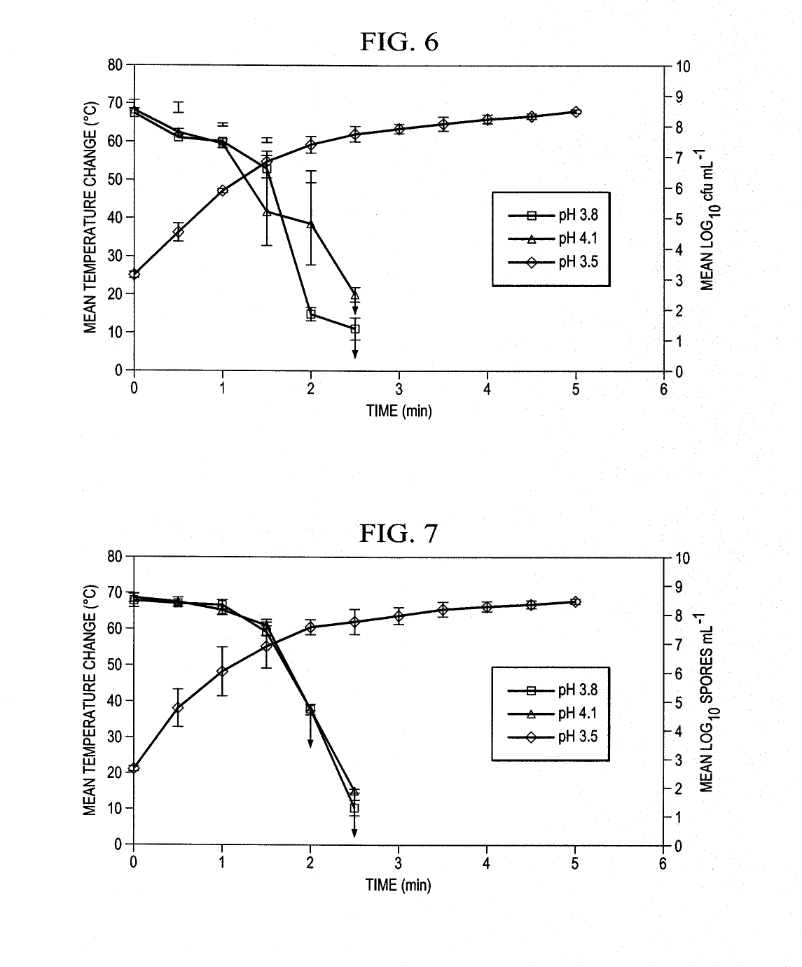

In certain embodiments, the in-package temperature was monitored for over 3.5 minutes after hot juice (84° C.) was added to room temperature (22.5° C.) pulp (FIG. 9). The temperature remained high enough over that length of time to cause a 6-log reduction in representative spoilage yeast, mold, or bacteria as demonstrated in the thermal death study data set (FIGS. 6-8).

### Example 2

### Thermal Death Studies (D- and Z-Values)

To test the efficiency of the system, thermal death studies with a selection of microorganisms including Penicillium crysogenum, Saccharomyces cerevisiae, and Gluconobacter spp as example for heat-sensitive microorganisms were conducted. The data demonstrate substantial microorganism inactivation in response to predetermined temperature, monitored in-package over time after adding hot juice with pulp.

In certain embodiments, a production process was performed using common spoilage microorganisms to demonstrate that hot, pasteurized juice filled on top of unpasteurized pulp can substantially inactivate microorganisms, which caused the product to be pasteurized and free of microorganisms or having a significantly reduced number of spoilage microorganisms. In certain studies, thermal death studies in the beverage mix were conducted while the temperature change in the package was monitored.

Disclosed are also examples in which heated juice was added to inoculated pulp in PET bottles. The resulting data were used to establish parameters for the in-package pasteurization of pulp.

Microorganism culture preparation was as follows: Cultures of certain microorganisms, such as yeast and bacteria, were grown aerobically in appropriate broth at the appropriate temperatures. A list of certain microorganisms used in this study is provided in the Table 1:

TABLE 1
List of certain microorganisms used.

| Spoilage Organism | Type of organism |
|---|---|
| Penicillium crysogenum | Mold |
| Penicillium glabrum | Mold, TCCC culture collection |
| Penicillium roqueforti | Mold, isolated from Gold Peak tea |
| Saccharomyces cerevisiae | Yeast, TCCC culture collection |
| Candida | Yeast, isolated from pulp |
| Gluconobacter spp. | Acidophilic bacteria, TCCC culture |
| | collection |

To determine the effect of pH on D- and z-values, orange juice pulp was used at a pH of 3.8. In this regard, D-value refers to decimal reduction time and is the time required at a certain temperature to kill 90% of the organisms being studied, and the z-value of an organism is the temperature required for the thermal destruction curve to move one log cycle.

For conducting the heat inactivation trials and determination of the D- and z-values, four heating temperatures were planned. An oil bath methodology was used to carry out the heat inactivation trials. Each inoculated product formulation was split into portions (2 ml) and transferred into sterile universal, screw-top, glass, wide-mouth vials with caps and bonded-in septa (Phenomenex, UK) and sealed. The rubber septum permitted the thin wire thermocouples to penetrate into the test material and to record its temperature profile. Three probes were reserved to monitor the oil temperature within the water-bath and the remaining probes were reserved to monitor the sample temperature during the heating period. Once the oil temperature was equilibrated to the target heating temperature, test vials containing the inoculated product were immersed in the oil bath, and the specific heating profiles were recorded by a data acquisition equipment. At the come-up times (time taken to reach the target temperature within the sample vials) and at pre-determined intervals during the heating process, test vials (in triplicate per organism) were removed and immediately immersed in ice to cool prior to sampling and enumeration. For enumeration, each vial was aseptically opened and the content was plated on an appropriate agar plates for enumeration. All trials were carried out in triplicates and data sets were plotted as mean survivor curves together with standard deviation error bars. All microorganisms were inactivated at the lowest target temperature, 68° C.

### Example 3

### Inoculation

Orange pulp and peach bits were mixed at a ratio of 50/50 (w/w) and heated to 80° C. for 10 minutes to kill any microorganisms present in the sample. The slurry was cooled to <50° C. (comfortably warm to the touch), and inoculated with microorganism to mimic the level of microorganisms that could be present based in ingredients. In this example, for orange pulp, 10³ and 10⁴ cfu/g pulp was the target inoculation; for peach bits, 10⁵ and 10⁶ cfu/g was the target inoculation. Inoculations were performed by aseptically transferring the microorganisms diluted in phosphate buffered saline. Inoculated pulp was plated out after each experiment to enumerate the microorganisms and to ensure that the inoculation was viable.

### Example 4

### In-Package Pasteurization Process

Inoculated pulp slurry was warmed. Thereafter, the pulp slurry was added to the bottle, the temperature was recorded, and pasteurized juice was filled to the top of the bottle. The bottle was capped and inverted for a set period of time and then held at room, temperature for at least 60 seconds. The bottle was then placed in a cold-water bath until it cooled to room temperature. Cooled inoculated pulp and pasteurized juice cooled to ambient temperature (as opposed to hot pasteurized juice) were added together as a positive control to demonstrate that it was the hot, pasteurized juice that killed or substantially inactivated the microorganisms.

### Example 5

### Testing for Colony Forming Microorganisms

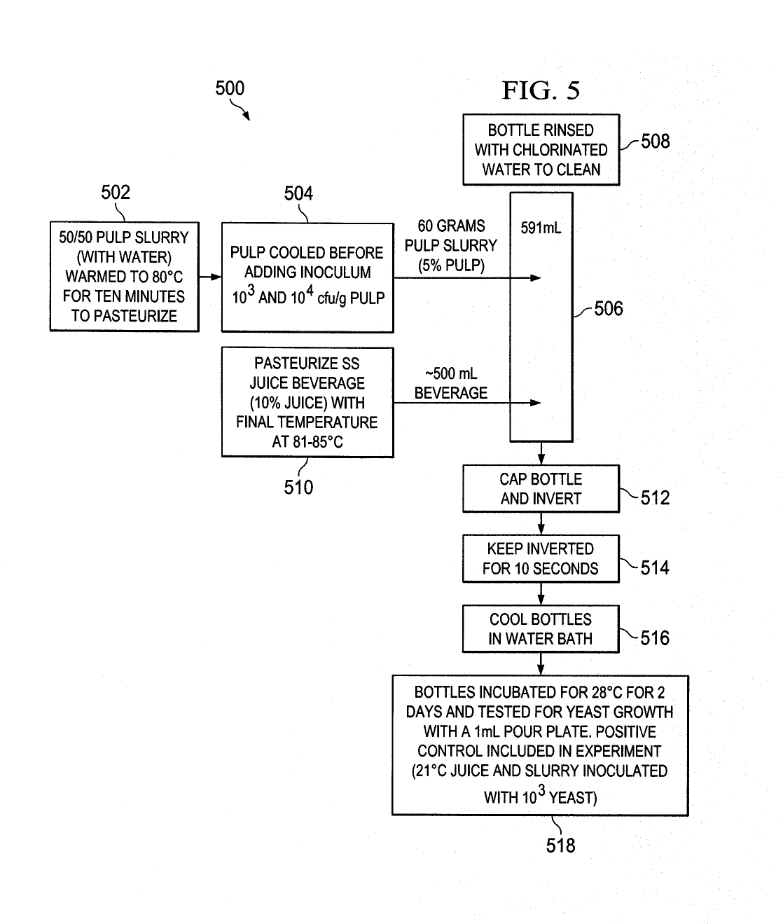

Beverages were incubated at 28° C. (ideal temperature for yeast, mold, and acidophilic bacteria) and tested at day 2 and day 7 for the presence of colony forming microorganisms. That incubation period is to ensure that the method is capable of detecting even small numbers or one individual microorganism, such as a yeast cell or mold spore, that survived the process. No growth is the desirable outcome in certain embodiments. A schematic illustration of the in-package pulp processing process 500 is depicted in FIG. 5. The process 500 is one embodiment used for testing the in-bottle pasteurization process in accordance with the principles of the present invention. Alternative processes may be utilized for testing the process or manufacturing using the in-package process, as well.

The testing process 500 started at step 502, where a 50/50 pulp slurry with water were warmed to about 80° C. for about 10 minutes to pasteurize the pulp. At step 504, the pulp was cooled prior to adding inoculum 10³ and 10⁴ cfu/g (colony forming unit per gram) of pulp. A sterilized container or consumer package 506 (e.g., bottle) having been rinsed with chlorinated water or other sterilization treatment at step 508 was filled with 60 grams of pulp slurry, which contains about 5% pulp. In addition, juice beverage with about 10% juice was pasteurized with a final temperature between about 81° C. and about 85° C. at step 510, and added to the consumer package 506 to form a fruit beverage. Alternative temperature ranges may be utilized, as well. At step 512, the consumer package 506 was capped and inverted, thereby inactivating any potential pathogens residing at the top of the package 506. The package 506 remained inverted for about 10 seconds at step 514, and cooled in a water bath at step 516. At step 518, the package 506 was incubated at about 28° C. for 2 days and tested for yeast growth with a 1 mL pour plate. Positive control included in the experiment included 21° C. juice and slurry inoculated with 10³ yeast.

### Example 6

### Thermal Death Studies

Heat inactivation of Gluconobacter spp. at 68° C. resulted in counts below the limit of detection (<10 cfu/ml) at the come-up time (time to reach target temperature). A heating profile for this organism was carried out to monitor the effect of the temperature change up to the target temperature (i.e. up to the come-up time), on the levels of the organism (FIG. 6). The results demonstrated that in the product with pH of 3.8 and 4.1, heating for more than 2.5 minutes (corresponding to temperatures higher than 62.05° C.) led to counts below the detectable limits (black arrows on figure). At pH 3.5, counts below the detection limits were obtained following 2 minutes within the heating profile (corresponding to temperatures higher than 59.2° C.).

Counts below the limits of detection were also obtained for Saccharomyces cerevisiae spores at the come-up time to the target temperature (68° C.). A heating profile for this strain indicated that in the product with pH of 3.8 and 4.1, heating for more than 2.5 minutes (corresponding to temperatures higher than 62.2° C.) led to counts below the detectable limits (black arrows on figure). At pH 3.5, counts below the detection limits were obtained following 2 minutes within the heating profile (corresponding to temperatures higher than 60.75° C.) (FIG. 7).

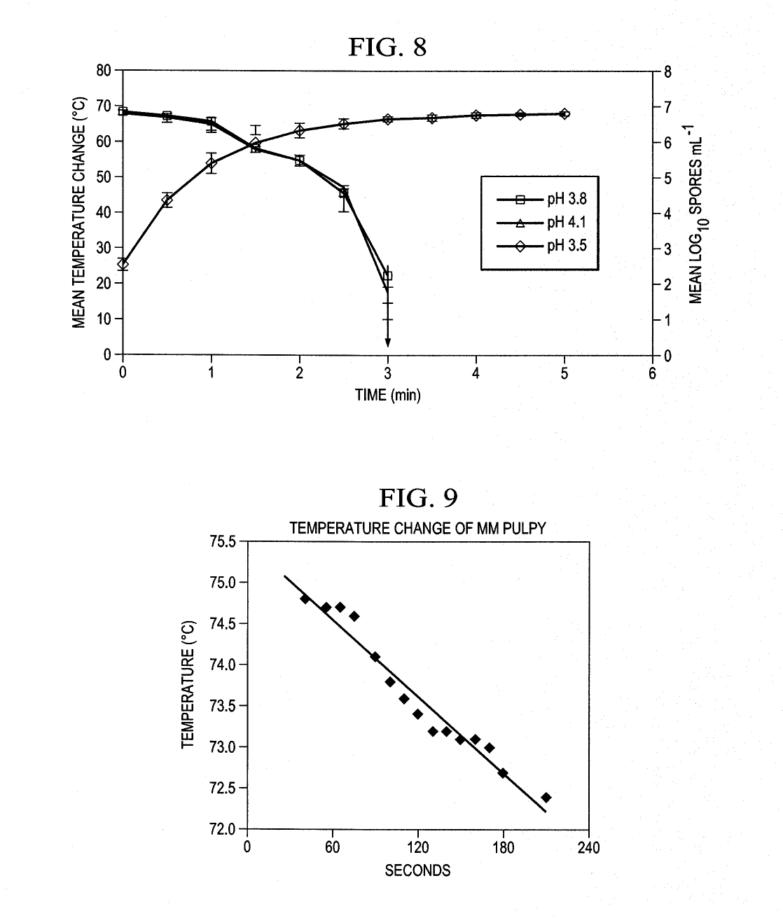

Spore counts below the limit of detection were also obtained for P. crysogenum at the come-up time to the target temperature (68° C.) in all three pH-formulations. A heating profile for this strain also showed that heating for more than 3 minutes (corresponding to temperatures higher than 66.5° C.) led to counts below the detectable limits (black arrows on figure) in all pH formulations (FIG. 8).

### Example 7

### Pulp Processing

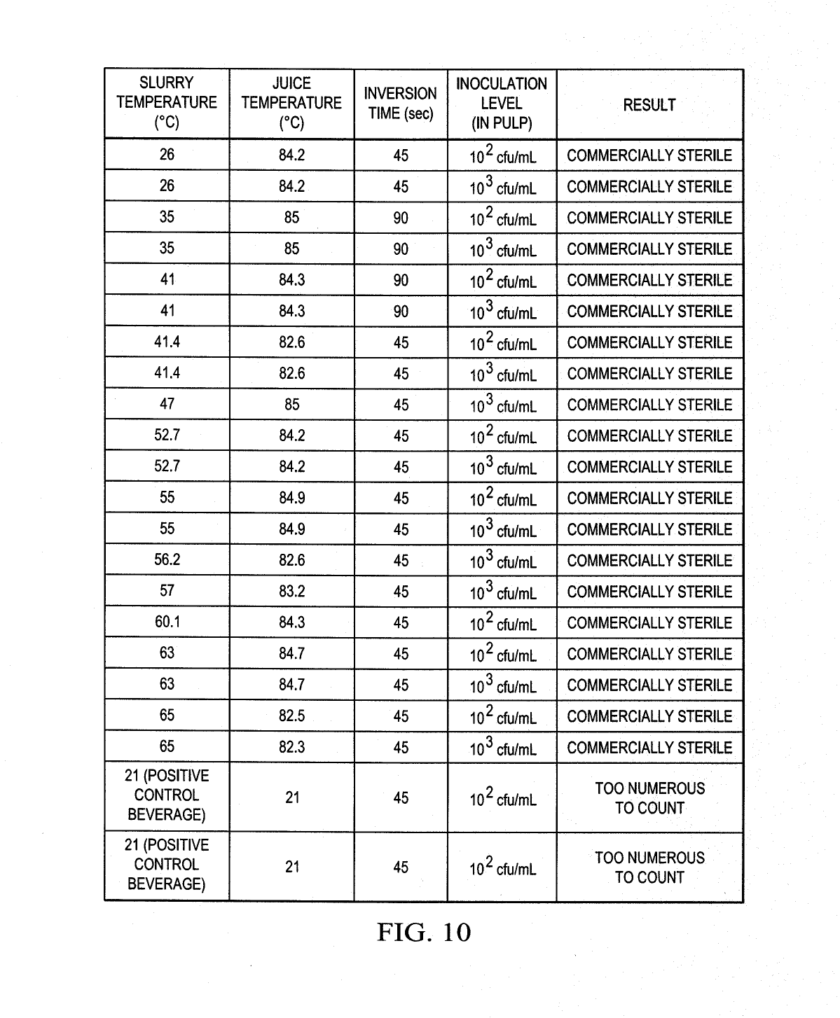

The examples surprisingly demonstrate that the in-package processing produces a pasteurized beverage in which heat-sensitive microorganisms are substantially inactivated so that these microorganisms cannot reproduce. In this regard, FIGS. 10-14 show results from different bench-top embodiments.

FIG. 10 illustrates the temperature range of embodiments over which the in-package process produced pasteurized beverages after inoculation with a cocktail of spoilage yeast. The data showed that with hold times of 45-90 seconds and pulp temperature of between about 26° C. and about 65° C. pasteurization was achieved.

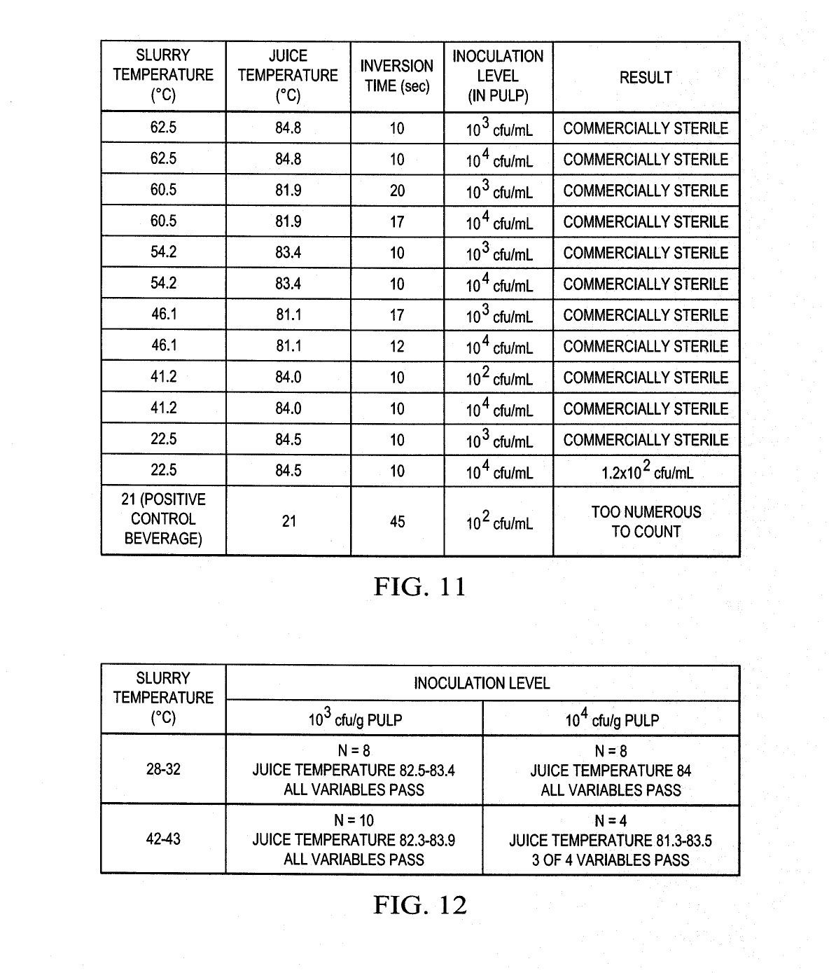

In FIG. 11, the microbial load of the cocktail was increased and the inversion time was reduced (inversion pasteurizes the headspace of the bottle). The results (FIG. 11) were in accordance with FIG. 10, with the exception that one of the variables at the lowest temperature was not pasteurized after 2 days incubation.

In FIG. 12, the bench-top, in-package process was conducted at two different temperatures with a higher number of replicates and with a cocktail of spoilage yeast (FIG. 12). Only one beverage did not pass the test (likely due to post-process contamination).

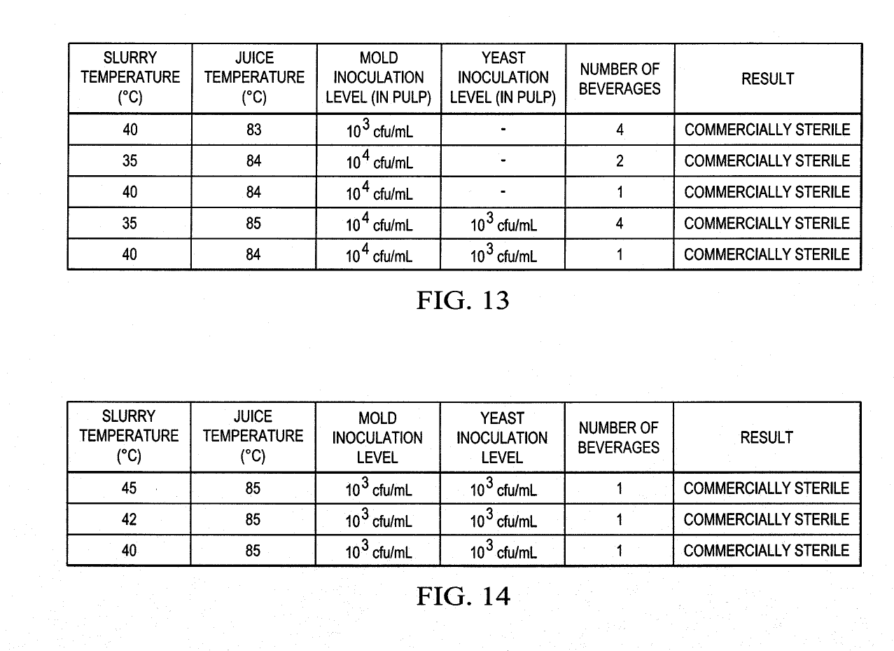

In FIG. 13, bench-top in-package process using pulp, was tested for its ability to pasteurize and substantially inactivate mold contamination. Both yeast and mold are major spoilage microorganisms. Results from this experiment were consistent with all other bench-top in-package trials. All pulp temperature variables tested resulted in pasteurized beverages with inoculations higher than those found in incoming ingredients.

For pulp processing, the results of these bench-top trials surprisingly demonstrated that the in-package process 1) maintained temperatures high enough to result in a 6-log reduction of common spoilage organisms, and 2) produced a beverage that was pasteurized over a wide range of pulp temperatures.

### Example 8

### Peach Bit Processing

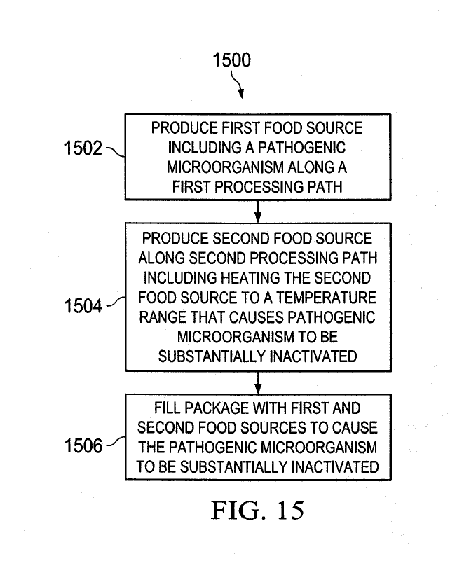

In certain embodiments, peach bits were employed and underwent the in-package process. In one embodiment, the peach bits were 6 mm×6 mm×6 mm peach chunks. FIG. 15 demonstrates that even with higher inoculation levels of yeast and mold, the microorganisms were substantially inactivated, and the beverages were pasteurized.

The data presented demonstrate that the in-package process delivers the same or better quality product at a lower cost by eliminating the pulp pasteurization step and allows hot pasteurized juice to kill or substantially inactivate microorganisms in the package via heat transfer to the non-pasteurized pulp

With regard to FIG. 15, a flow diagram of a process 1500 for producing a packaged food article or beverage is shown. The process 1500 may start at step 1502, where a first food source including a spoilage microorganism may be processed along a first processing path. The first processing path may limit temperature of the first food source to be below a temperature level that would cause the spoilage microorganism to be inactivated. The temperature level may be a pasteurization temperature level that substantially inactivates one or more spoilage microorganisms. The first food source may be pulp. The pulp may be frozen pulp.

At step 1504, a second food source may be produced along a second processing path that heats the second food source to a temperature range that causes spoilage microorganisms to be substantially inactivated. The second food source may be a liquid, such as juice, and more particularly, but not by limitation, an orange juice. The temperature range may be a pasteurization temperature range for juice, for example.

At step 1506, a package may be filled with the first and second food sources while the second food source is in the temperature range, thereby causing the spoilage microorganisms to be substantially inactivated. In being substantially inactivated, the spoilage microorganisms are to have minimal trace levels, as understood in the art. In one embodiment, the combined first and second food sources produces an orange juice with pulp. Other foods, beverages, juices, or consumable foods or beverages by humans or animals may be produced using the principles of the present invention.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed:

1. A packaged food article or beverage comprising:
a consumer package;
a processed food composition including a spoilage microorganism; and
a liquid being at a temperature in a predetermined temperature range applied to said processed food composition to form a first mixture in the consumer package that, as a result of said liquid being in the predetermined temperature range for a predetermined period of time, causes the spoilage microorganism to be substantially inactivated.

2. The packaged article or beverage of claim 1, wherein said consumer package is plastic or glass packaging.

3. The packaged article or beverage of claim 1, wherein said consumer package is a bottle or cup and includes a cover.

4. The packaged food article or beverage of claim 1, wherein said consumer package is a bottle or cup and includes a cover.

5. The packaged food article or beverage of claim 1, wherein said processed food composition is fruit pulp or food bits.

6. The packaged food article or beverage of claim 5, wherein said first mixture includes about 2 wt % pulp to about 15 wt % pulp.

7. The packaged food article or beverage of claim 1, wherein said processed food composition is derived from fruits, vegetables, nuts, or food grade polymers.

8. The packaged food article or beverage of claim 1, wherein said processed food composition includes pulp or fruit bits from citrus fruits selected from the group consisting of oranges, sweet oranges, clementines, kumquats, limes, leeche limes, satsumas, mandarins, tangerines, citrons, pummelos, lemons, rough lemons, grapefruits, tangerines, tangelos, hybrids thereof, and combinations thereof.

9. The packaged food article or beverage of claim 1, wherein said processed food composition includes pulp or fruit bits from non-citrus fruits selected from the group consisting of kiwi, mango, grapes, banana, berries, pears, apples, peach, pineapple, melon, apricots, strawberries, raspberries, blackberries, blackcurrants, blueberry, red currant, nectarine, cranberry, passion fruit, papaya, lychees, pomegranate, fig, plum, cherry, gooseberry, summer squash, persimmon, dates, guava, rhubarb, coconuts, and combinations thereof.

10. The packaged food article or beverage of claim 1, wherein said processed food composition is a pulp selected from the group consisting of citrus pulp, orange pulp, grapefruit pulp, peach chunks, mango chunks, aloe vera, and combinations thereof.

11. The packaged food article or beverage of claim 1, wherein said processed food composition includes food-grade polymers to form edible bits consisting of gelatin, pectins, alginate, or cellulose.

12. The packaged food article or beverage of claim 1, wherein said processed food composition comprises food particles generated through culturing fruit or vegetables, and wherein said liquid comprises water, sparkling water, juice or broth.

13. The packaged food article or beverage of claim 1, wherein said processed food composition is in a thawed state.

14. The packaged food article or beverage of claim 13, wherein said first mixture exhibits improved characteristics as compared to an equivalent mixture in which said processed food and said liquid are separately pasteurized.

15. The packaged food article or beverage of claim 14, wherein said improved characteristics are selected from the group consisting of flavor, texture and mouth feel.

16. The packaged food article or beverage of claim 1, wherein the spoilage microorganism includes a heat-sensitive spoilage microorganism, wherein the heat-sensitive spoilage microorganism is substantially inactivated by the temperature at the predetermined temperature range.

17. The packaged food article or beverage of claim 1, wherein the first mixture has a maximum equilibrium temperature, wherein the maximum equilibrium temperature is capable of pasteurizing the first mixture, but not capable of substantially inactivating heat-resistant microorganisms.

18. The packaged food article or beverage of claim 1, wherein the spoilage microorganism includes a spoilage microorganism selected from the group consisting of bacteria, virus, fungi, and yeast.

19. The packaged food article or beverage of claim 1, wherein said liquid is selected from the group consisting of water and juice.

20. The packaged food article or beverage of claim 1, wherein said liquid comprises pectin.

21. The packaged food article or beverage of claim 1, wherein said processed food composition has a temperature of between about 26° C. and about 65° C.

22. The packaged food article or beverage of claim 1, wherein said processed food composition has a temperature within a temperature range selected from about 25° C. to about 55° C., about 25° C. to about 45° C., about 25° C. to about 35° C., or about 23° C. to about 30° C.

23. The packaged food article or beverage of claim 1, wherein said liquid is at a temperature range from about 72° C. to about 90° C.

24. The packaged food article or beverage of claim 1, wherein said liquid is at a temperature range that substantially inactivates heat-sensitive spoilage microorganisms but does not inactivate heat-resistant organisms.

25. The packaged food article or beverage of claim 1, wherein said liquid is at a temperature range from about 82° C. to about 90° C.

26. The packaged food article or beverage of claim 1, wherein said liquid is at a temperature range from about 66° C. to about 80° C. for a maximum of 3 minutes.

27. The packaged food article or beverage of claim 1, wherein said packaged food article or beverage is maintained at a temperature range of about 75° C. to about 87° C. for about 2 minutes to about 5 minutes.

28. The packaged food article or beverage of claim 1, wherein said packaged food article or beverage is incubated at room temperature for at least about 60 seconds.

29. A method for manufacturing a packaged food article or beverage, said method comprising:
providing a processed food composition including a spoilage microorganism;
pasteurizing a liquid being used to form the food article or beverage, the pasteurization including heating the liquid to a predetermined temperature range; and
combining, in a consumer package, the liquid in the predetermined temperature range and the processed food composition to form a first mixture, such that the liquid in the predetermined temperature range causes the spoilage microorganism to be substantially inactivated.

30. The method of claim 29, wherein said consumer package is plastic or glass packaging.

31. The method of claim 29, wherein said consumer package is a bottle or cup and includes a cover.

32. The method of claim 29, wherein said processed food composition is derived from fruits, vegetables, and nuts.

33. The method of claim 29, wherein said processed food composition includes food-grade gel particles.

34. The method of claim 29, wherein said processed food composition includes coco de nato.

35. The method of claim 29, wherein said processed food composition includes peach chunks.

36. The method of claim 29, wherein said processed food composition is fruit pulp.

37. The method of claim 29, wherein said processed food composition is a pulp selected from the group consisting of citrus pulp, orange pulp, grapefruit pulp, peach chunks, mango chunks, and aloe vera.

38. The method of claim 29, wherein said processed food composition includes peach chunks.

39. The method of claim 29, wherein said first mixture includes about 2 wt. % pulp to about 15 wt. % pulp.

40. The method of claim 29, wherein said processed food composition is in a thawed state.

41. The method of claim 29, wherein when said first mixture exhibits improved characteristics as compared to an equivalent mixture in which said processed food and said liquid are separately pasteurized.

42. The method of claim 41, wherein said improved characteristics are selected from the group consisting of flavor, texture, and mouth feel.

43. The method of claim 29, wherein the spoilage microorganism is selected from the group consisting of bacteria and fungi.

44. The method of claim 29, wherein the liquid is selected from the group consisting of water and juice.

45. The method of claim 29, wherein the liquid includes pectin.

46. The method of claim 29, wherein the processed food composition has a temperature ranging from about 26° C. to about 65° C.

47. The method of claim 29, wherein the processed food composition has a temperature within a temperature range selected from about 25° C. to about 55° C., about 25° C. to about 45° C., about 25° C. to about 35° C., or about 23° C. to about 30° C.

48. The method of claim 29, wherein the liquid is at a temperature range from about 81° C. to about 90° C.

49. The method of claim 29, wherein the liquid is at a temperature range from about 81° C. to about 90° C.

50. The method of claim 29, wherein the consumer package is a bottle, and further comprising:
capping the bottle; and
inverting the bottle.

51. The method of claim 29, further comprising maintaining the packaged food article or beverage at a temperature range of about 63° C. to about 87° C. for about 2 minutes to about 5 minutes.

52. The method of claim 29, further comprising maintaining the packaged food article or beverage at a temperature range of about 70° C. to about 82° C. for a maximum of about 4 minutes.

53. The method of claim 29, further comprising incubating said packaged food article or beverage at room temperature for at least about 60 seconds.

54. The method of claim 29, wherein said mixture is maintained at a predetermined temperature for at least about 5 seconds.

55. The method of claim 29, wherein substantial inactivation reduces the microbial count to less then about 10 cfu/mg.

56. A packaged food article or beverage prepared by the method of claim 29.
